(19) United States
(12) Patent Application Publication
(10) Pub. No.: US 2023/0116725 A1
(43) Pub. Date: Apr. 13, 2023

(54) Method For Converting Elements, Such As Calcium, Copper, Magnesium, And Cesium, Into More Useful Elements, And A Method For Making Radioactive Substances Harmless By Applying This Element Conversion Method

(71) Applicant: Japan Techno Co., Ltd., Tokyo (JP)

(72) Inventor: Ryushin OMASA, Kanagawa (JP)

(21) Appl. No.: 17/938,683

(22) Filed: Oct. 7, 2022

Related U.S. Application Data
(63) Continuation of application No. 15/553,709, filed on Aug. 25, 2017, now abandoned.

(51) Int. Cl. G21G 7/00; G21F 9/06; G21F 9/00; B01F 31/44; B01F 31/80; B01F 33/25

(52) U.S. Cl. CPC G21G 7/00; G21F 9/06; G21F 9/00; B01F 31/44; B01F 31/80; B01F 33/252; B01F 2101/57

(57) ABSTRACT

The method according to the present invention comprises using a high-frequency vibrating stirrer that is confirmed to include a treatment tank I, a high-frequency vibrating motor 3 fixed to a table positioned above the treatment tank 1, two vibrating rods 4 extending toward the bottom of the treatment tank 1 and coupled to the table, and multistage vibrating blades 5 mounted to the lower parts of the vibrating rods 4 and surface-plated with palladium or platinum serving as a catalyst in element transmutation, characterized in that the high frequency vibrating motor 3 is controlled by an inverter 6 so as to vibrate the multistage vibrating blades 5 at a frequency of 100-170 Hz in an aqueous solution 2 containing an element to be transmuted in the treatment tank 1, thereby transmuting the element in the aqueous solution 2 into another element. By adding heavy water to the solution to be treated, the transmutation efficiency can be elevated. By adding tritium water with an appropriate concentration as a substitute for the heavy water, the element transmutation can be completed within a short period of time and, at the same time, the tritium water that is seemingly the main cause of radioactive contamination can be effectively utilized and the radioactivity thereof can be attenuated or detoxified.

### CROSS-REFERENCE TO THE RELATED APPLICATION

The present application is a Continuation application of application Ser. No. 15/553,709, filed Aug. 25, 2017, which is the National Stage filing under 35 U.S.C. § 371 of PCT Application Ser. No. PCT/JP2015/055395, filed Feb. 25, 2015, the contents of which are incorporated herein by reference in their entireties.

### TECHNICAL FIELD

The present invention relates to methods for converting an element into another element by using the energy of high-frequency vibration agitation and the burst energy of nano or micro bubbles generated through the electrolysis of water with the vibrating vanes of the high-frequency vibration agitator as electrodes, and enhancing the catalytic effect by plating the vibrating vanes with palladium, and methods for making radioactive substances, such as radioactive cesium 137 and 134, harmless.

### BACKGROUND ART

For the cutting-edge technologies in the electronic and automobile industries, scarce elements, such as rare earth and rare metal, are crucial and essential, but trace amounts of these elements exist only in certain places. Accordingly, the technology for artificially producing these scare elements has been pursued at a national level. It has been achieved at a laboratory level, but the practical technology has not been actualized yet. There remains significant difficulty.

When “common salt” is extracted from seawater, several millions of tons of magnesium chloride are produced as “waste” every year, and we are faced with difficulty in disposing of the waste.

Also in “Fukushima,” which is suffering contaminated soil and water with radioactive substances, the only technique is to reduce the volume of radioactive substances by using zeolite and special furnace materials. It is imperative to solve this problem, which affects not only Fukushima, but also the existence of a nation or the entire humankind. However, there is no helpful technology, and it is necessary to invent an innovative technology as soon as possible.

The inventor identified that when water undergoes electrolysis through special vibration agitation, nano or micro bubbles (of oxygen and hydrogen gases) are produced and when these bubbles burst, strong energy is generated (See, for example, Patent Documents 1 to 3). Patent Documents 1 and 2 describe that vibration agitation leads to the production of nano and micro bubbles, while Patent Document 3 mentions a method for producing a combustible gas from carbon dioxide gas and water by applying the nano and micro bubbles.

### PRIOR ART DOCUMENTS

### Patent Documents

Patent Document 1: Specifications of JP Pat. No. 2852878
Patent Document 2: Specifications of JP Pat. No. 4269318

### Patent Document 3: PCT/JP2014/066551

### OUTLINE OF THE INVENTION

### Problem to be Solved with the Invention

On Sep. 11, 2013, the application was submitted for a patent of a method for converting elements and making radioactive substances harmless by applying the above mentioned nano and micro bubbles and high-frequency vibration agitation, but conversion efficiency was not satisfactory, and the elements to be converted were limited to calcium and cesium. In this situation, the object of the present invention is to improve the method that combines nano and micro bubbles and high-frequency vibration agitation to apply element conversion to the above mentioned magnesium chloride and contaminated water with radioactive substances, etc. and increase conversion efficiency.

### Method for Solving the Problem

The present invention is a method of converting elements in several hours or days to solve the problem by plating the multi-step vibrating vanes of a vibration agitator with palladium and platinum with a thickness of 2 to 5 μm, adding heavy water to the aqueous solution of the element to be converted so that a concentration will be 0.1 to 5%, and stirring it at a vibration frequency of 100 to 170 Hz or a method for converting elements more rapidly than the case of heavy water by adding a certain amount of diluted tritium (0.1 to 5 μSv) instead of “heavy water” as a catalyst for element conversion, in order to obtain scarce elements, such as rare metal and rare earth, by converting abundant elements, such as calcium, magnesium, and iron or reduce radioactivity to the tolerable level for the human body by converting radioactive substances, such as cesium, into barium, silver, gold, and platinum.

In detail, any of the following methods (1) to (8) would solve the problem.

(1) A method using a high-frequency vibration agitator comprising a tank, a high-frequency vibration motor set on a mount at the upper part of said tank, two vibrating rods that are connected to said mount and extend downward in said tank, and multistep vibrating vanes that are attached to the lower parts of said vibrating rods and plated with palladium or platinum, which functions as a catalyst for element conversion, wherein said high-frequency vibration motor is controlled by an inverter and vibrates said multistep vibrating vanes at a frequency of 100 to 170 Hz in an aqueous solution including the element to be converted in said tank, to convert said element in the solution to another element.

(2) A method described in the above section (1), wherein heavy water is added to said aqueous solution with a concentration of 0.1 to 5% to shorten the duration of element conversion.

(3) A method described in the above section (1), wherein tritium water of 0.5 to 5 μSv is added to said aqueous solution with a concentration of 5 to 50% to shorten the duration of element conversion, while utilizing the tritium water, which is said to cause radioactive contamination and considerably mitigating or eliminating the radioactivity of the tritium at the same time.

(4) A method described in the above section (1) or (2), wherein said multistep vibrating vanes are equipped with positive and negative electrodes and nano or micro bubbles are produced by applying an electric current of 0.5 to 4 A/dm² to said electrodes to improve the efficiency of element conversion.

(5) A method described in any of the above sections (1) to (3), wherein said aqueous solution is treated at ordinary temperatures (15 to 30° C.).

(6) A method described in any of the above sections (1) to (3), wherein there is no adverse effect of temperature increase in aqueous solution during element conversion.

(7) A method described in the above section (1), wherein said tank is closed or open, and when gases generated during element conversion are treated, said tank is connected via a pipe to a bubbling tank that contains pure water or 3% potassium hydroxide solution, which treats the gasses generated during element conversion.

(8) A method described in the above section (7), wherein said tank is made from resin or metal including stainless steel.

(9) A method for making tritium water harmless, wherein tritium water undergoes vibration-flow agitation at a frequency of 170 Hz for 25 hours to reduce the tritium concentration to one sixteenth in a tank described in the above section (1) comprising a high-frequency vibration agitator that includes multistep vibrating vanes plated with palladium with a thickness of 3 to 5 μm as a catalyst.

### Advantageous Effects of the Invention

With the present invention, it became possible to make radioactive elements harmless at low cost by simple technology, convert abundant elements, such as calcium, into scarce elements, such as cobalt and nickel, and copper into gold and silver, and contribute significantly to the conservation of the Earth environment and resources.

### BRIEF DESCRIPTION OF DRAWINGS

FIG. 1 FIGS. 1A and 1B are cross-sectional views of a high-frequency vibration agitator with electrodes. FIG. 1A is a front cross-sectional view, and FIG. 1B is a side cross-sectional view.

FIG. 2 is a cross-sectional view of a bubbling tank.

FIG. 3 is an enlarged diagram of the multistep vibrating vanes of the high-frequency vibration agitator with electrodes shown in FIGS. 1A and 1B.

### DESCRIPTION OF EMBODIMENTS

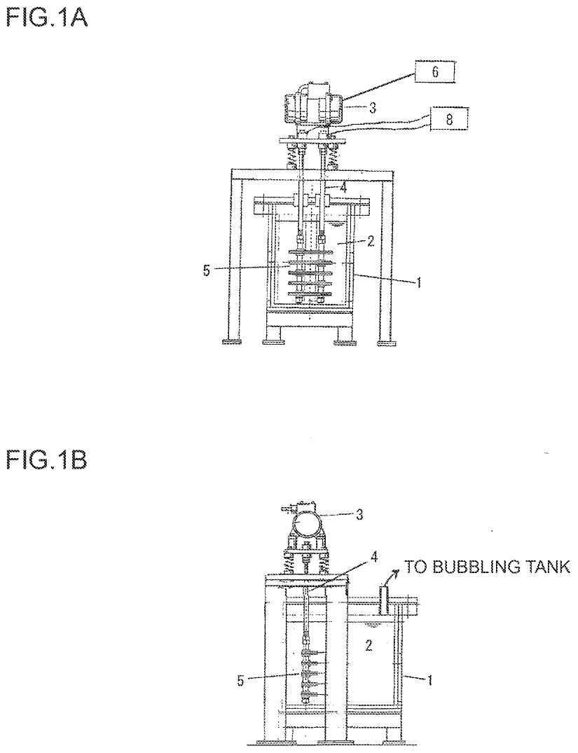

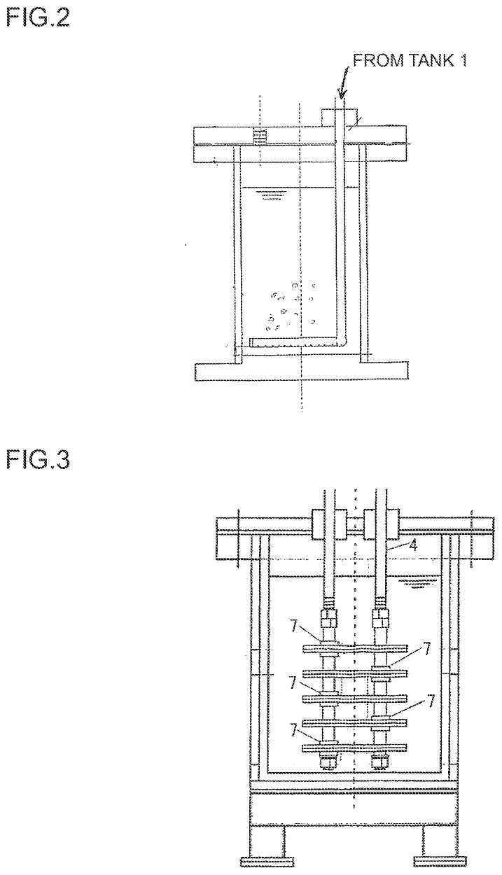

A system for converting elements and making radioactive elements harmless is composed of a high-frequency vibration agitator with electrodes shown in FIGS. 1A and 1B and a bubbling tank (air cushion tank) shown in FIG. 2. The high-frequency vibration agitator with electrodes comprises a tank 1, into which an aqueous solution 2 including the element to be converted is poured. A high-frequency vibration motor 3 is set on a mount at the upper part of the tank 1. Two vibrating rods 4 are connected to this mount, and extend downward into the tank 1. Multistep vibrating vanes 5 are attached to the lower parts of the vibrating rods 4. The high-frequency vibration motor 3 is controlled by an inverter 6, so as to vibrate the multistep vibrating vanes 5 at a frequency of 100 to 170 Hz inside the liquid of the tank 1.

As indicated by the enlarged diagram of the multistep vibrating vanes in FIG. 3, the multistep vibrating vanes 5 are attached to the two vibrating rods 4. The first vibrating vane is connected physically and electrically to the right vibrating rod, and connected physically to the left vibrating rod, but electrically insulated from the left vibrating rod by an insulator 7. The second vibrating vane is connected physically to the right vibrating rod, but electrically insulated from the right vibrating rod by the insulator 7, and connected physically and electrically to the left vibrating rod. Like this, the vibrating vanes are electrically connected to and insulated from the right and left vibrating rods alternately, so that the right and left vibrating rods are electrically insulated from each other. Accordingly, it is possible to form a direct-current voltage applied circuit with multiple vibrating vanes 5 functioning as positive and negative electrodes, that is, an electrolytic circuit, by connecting a direct-current power source to the right and left vibrating rods via a rectifier 8. A vibrating vane 5 is 55 mm wide, 100 mm long, and 0.5 mm tall, and five vibrating vanes are used as shown in FIG. 3. Each vibrating vane 5 is plated with palladium with a thickness of 2 to 5 μm, in order to boost the catalytic effect during element conversion. Platinum can be used instead of palladium. The catalytic effect of palladium is obvious from Tables 1 and 2, which summarize the results of the later mentioned embodiments 1 and 2. The palladium-plated embodiment will be compared with the palladium-less one later in detail.

With the above mentioned structure, the tank 1 can carry out high-frequency vibration only, or both high-frequency vibration-flow and electrolysis at the same time. The tank can be made of resin or metal, such as stainless steel. The material for the tank can be selected according to usage conditions.

When electrolysis is conducted, direct-current voltage (DC 12V) is applied to the two vibrating rods 4 via the rectifier 8. At that time, current density should be set at 0.5 to 4 A/dm².

FIG. 2 is a cross-sectional view of a bubbling tank. For the purpose of preventing radioactive elements, etc. from accompanying the oxyhydrogen gas produced through the electrolysis at the vibration agitator (OHMASA-GAS) and being released to the atmosphere, a bubbling tank is connected via a pipe to the top of the tank 1, so that the gas produced in the tank 1 of the high-frequency vibration agitator is injected from the top of the bubbling tank into the pure water or 3% potassium hydroxide solution.

With this system, element conversion is conducted by combining high-frequency agitation and electrolysis as follows, while expecting the effects of the strong burst energy of nano and micro bubbles, which are produced during the electrolysis of water.

1) To pour an aqueous solution 2 including the element to be converted into the tank 1 of the high-frequency agitator with electrodes. It is desirable to add heavy water to the aqueous solution 2 with a concentration of 0.1 to 5%, in order to complete element conversion efficiently in a short period of time. If tritium water of 0.5 to 5 μSv is added with a concentration of 5 to 50% instead of heavy water, the duration of element conversion can be shortened, while effectively utilizing tritium water, which is said to cause radioactive contamination. The effects of tritium water will be described later.

2) To set the frequency of the high-frequency vibration motor 3 with the inverter 6, and apply electric current.

3) To set electrolytic voltage and current value with the electrolytic rectifier 8 (starting the element conversion process).

4) To do the element conversion process for a specified period of time.

5) To turn off the electrolytic rectifier 8.

6) To turn off the high-frequency vibration motor 3.

7) To stir the aqueous solution 2 in the tank 1 for three minutes to homogenize it, sample the treated liquid, and measure the element content. The amounts of copper, nickel, cobalt, titanium, silver, and gold were measured with the ICP mass spectrometer HP-4500 produced by Yokogawa Analytical Systems, Inc. In addition, the amounts of calcium, magnesium, iron, and zinc were measured with the ICP emission spectrometer iCAP6300 produced by Thermo Fisher Scientifics Inc.

The following sections will describe some embodiments of the above system under different conditions.

### Embodiment 1

0.5% calcium chloride solution was put into the tank 1, heavy water was added with a concentration of 5 g/L (about 0.5%), and the high-frequency agitator vibrated the vibrating vanes 5 at 170 Hz for 3 hours. Table 1 shows the results. In addition, in order to check the catalytic effect of palladium, the element conversion process was carried out with palladium-plated agitation vanes and also with palladium-less vanes. The temperature of the aqueous solution before the process was 18.6° C., while that after the process was 18.5° C. no matter whether the vanes are plated with palladium, indicating no significant change.

TABLE 1
(Heavy water added as a catalyst: 5 g/L) Unit: mg/L

| Chemical component | Calcium | Iron | Copper | Nickel | Cobalt | Titanium |
|---|---|---|---|---|---|---|
| Concentration before the process | 1,400 | 0.116 | 0.012 | 0.013 | 0.001 | <0.001 |
| Concentration after the process | 1,050 | 0.5 | 11 | 9 | 7 | 12 |
| Concentration after the process*1 | 890 | 2 | 31 | 26 | 14 | 23 |

*1The agitation vanes are plated with palladium.
The temperature of the aqueous solution was 18.6° C. before the process, and 18.5° C. after the process.

As a result, when the agitation vanes were not plated with palladium, calcium with a concentration of 1,400 mg/L was converted into more useful elements, including iron (0.5 mg/L), copper (11 mg/L), nickel (9 mg/L), cobalt (7 mg/L), and titanium (12 mg/L), decreasing the calcium concentration to 1,050 mg/L. When the agitation vanes were plated with palladium, the calcium was converted into iron (2 mg/L), copper (31 mg/L), nickel (26 mg/L), cobalt (14 mg/L), and titanium (23 mg/L), decreasing the calcium concentration to 890 mg/L. This result verifies the catalytic effect of palladium, and indicates that palladium increases element conversion efficiency two to three times, depending on element.

### Embodiment 2

1% copper chloride solution was put into the tank 1, heavy water was added with a concentration of 5 g/L (about 0.5%), and the high-frequency agitator vibrated the vibrating vanes 5 at 170 Hz for 3 hours. Table 2 shows the results. Like the case of Embodiment 1, in order to check the catalytic effect of palladium, the element conversion process was carried out with palladium-plated agitation vanes and also with palladium-less vanes. The temperature of the aqueous solution before the process was 18.2° C., while that after the process was 18.4° C., indicating no significant change.

TABLE 2
(Heavy water added as a catalyst: 5 g/L) Unit: mg/L

| | Chemical component | | | | |
|---|---|---|---|---|---|
| | Copper | Silver | Gold | Nickel | Zinc |
| Concentration | 4,200 | <0.012 | <0.001 | 0.015 | 0.018 |
| before the | | | | | |
| process | | | | | |
| Concentration | 2,800 | 11 | 8 | 12 | 16 |
| after the process | | | | | |
| Concentration | 1,900 | 34 | 26 | 27 | 31 |
| after the | | | | | |
| process*1 | | | | | |

*1The agitation vanes are plated with palladium.
The temperature of the aqueous solution was 18.2° C. before the process, and 18.4° C. after the process.

When the agitation vanes were not plated with palladium, copper with a concentration of 4,200 mg/L was converted into more useful elements, including silver (11 mg/L), gold (8 mg/L), nickel (12 mg/L), and zinc (16 mg/L), decreasing the cooper concentration to 2,800 mg/L.

When the agitation vanes were plated with palladium, the copper was converted into silver (34 mg/L), gold (26 mg/L), nickel (27 mg/L), and zinc (31 mg/L), decreasing the copper concentration to 1,900 mg/L. This result verifies the catalytic effect of palladium, and indicates that palladium increases element conversion efficiency two to three times, depending on element.

### Embodiment 3

0.5% magnesium chloride solution was put into the tank 1, heavy water was added with a concentration of 5 g/L (about 0.5%), and the high-frequency agitator vibrated the palladium-plated vibrating vanes 5 at 170 Hz for 3 hours. Table 3 shows the results. The temperature of the aqueous solution before the process was 18.4° C., while that after the process was 18.5° C., indicating no significant change.

TABLE 3
(Heavy water added as a catalyst: 5 g/L) Unit: mg/L

Chemical component

| | Magnesium | Gold | Silver | Copper |
|---|---|---|---|---|
| Concentration | 1,760 | <0.001 | <0.001 | <0.001 |
| before the | | | | |
| process | | | | |
| Concentration | 1,020 | 14 | 32 | 48 |
| after the | | | | |
| process*1 | | | | |

*1The agitation vanes are plated with palladium.
The temperature of the aqueous solution was 18.4° C. before the process, and 18.5° C. after the process.

As a result, magnesium with a concentration of 1,760 mg/L was converted into gold (14 mg/L), silver (32 mg/L), and copper (48 mg/L), decreasing the magnesium concentration to 1,020 mg/L.

### Embodiment 4

1% cesium chloride solution was put into the tank 1, heavy water was added with a concentration of 5 g/L (about 0.5%), and the high-frequency agitator vibrated the vibrating vanes 5 at 170 Hz for 3 hours. Table 4 shows the results. Table 4 also shows the results of the case where tritium water of 0.5 μSv was added with a concentration of 5 g/L instead of heavy water. The temperature of the aqueous solution before the process was 19.8° C., while that after the process was 20.0° C. for heavy water and 20.2° C. for tritium water, indicating no significant change.

TABLE 4
(The agitation vanes are plated with palladium.) Unit: mg/L

| Chemical component | Cesium | Barium | Tungsten | Platinum | Gold | Silver | Copper | Zinc | Nickel | Iron |
|---|---|---|---|---|---|---|---|---|---|---|
| Concentration | 6,700 | 0.021 | <0.01 | <0.001 | <0.001 | <0.001 | <0.01 | <0.018 | <0.001 | <0.021 |
| before the | | | | | | | | | | |
| process | | | | | | | | | | |
| Concentration | 4,800 | 48 | 22 | 24 | 18 | 8 | 4 | 16 | 5 | 18 |
| after the | | | | | | | | | | |
| process*2 | | | | | | | | | | |
| Concentration | 3,880 | 58 | 40 | 51 | 42 | 19 | 10 | 25 | 22 | 33 |
| after the | | | | | | | | | | |
| process*3 | | | | | | | | | | |

*2Heavy water is added as a catalyst: 5 g/L
*3Tritium water of 0.5 μSv is added as a catalyst: 5 g/L. After the process, the radiation dose dropped to 0.05 μSv or less. The temperature of the aqueous solution before the process was 19.8° C., while that after the process was 20.0° C. for heavy water and 20.2° C. for tritium water.

As a result, when heavy water was added, cesium with a concentration of 6,700 mg/L was converted into barium (48 mg/L), tungsten (22 mg/L), platinum (24 mg/L), gold (18 mg/L), silver (8 mg/L), copper (4 mg/L), zinc (16 mg/L), nickel (5 mg/L), and iron (18 mg/L), decreasing the cesium concentration to 4,800 mg/L.

When tritium water was added, cesium with a concentration of 6,700 mg/L was converted into barium (58 mg/L), tungsten (40 mg/L), platinum (51 mg/L), gold (42 mg/L), silver (19 mg/L), copper (10 mg/L), zinc (25 mg/L), nickel (22 mg/L), and iron (33 mg/L), decreasing the cesium concentration to 3,880 mg/L. The comparison of these results indicates that tritium water improves element conversion, producing higher concentrations of elements than heavy water.

In addition, the radiation level of tritium decreased from 0.5 μSv to 0.05 μSv or less through the 3-hour process. It can be concluded that the vibration and flow of the solution in this invention are very effective for considerably mitigating or eliminating the radioactivity of tritium.

### Embodiment 5

Tritium water was put into the tank 1, and the high-frequency agitator vibrated the multistep vibrating vanes 5 plated with palladium with a thickness of 3 to 5 μm at 170 Hz for 25 hours. Table 5 shows the radiation level of tritium water measured at 5-hour intervals. The radiation level was measured with the survey meter SMSD produced by Sensortechnik and Elektronik Pockau GmbH in Germany.

TABLE 5
Unit: μSv

| | Process time [hours] | | | | | |
|---|---|---|---|---|---|---|
| | Before processed | 5 | 10 | 15 | 20 | 25 |
| Radiation level | 0.8 | 0.5 | 0.35 | 0.12 | 0.084 | 0.051 |

*The radiation level was measured with the survey meter SM5D produced by Sensortechnik und Elektronik Pockau GmbH in Germany.

As clearly shown in Table 5, the radiation level of tritium dropped from 0.8 μSv to 0.35 μSv, indicating an over-50% decrease through the 10-hour process; to 0.084 μSv, nearly one tenth through the 20-hour process; and to 0.051 μSv, nearly one sixteenth, through the 25-hour process.

During the process of tritium water, the tank 1 got filled with a “gas” that is considered as “helium,” and the liquid became turbid due to “air bubbles.” This white turbidity is considered because tritium contacts the vibrating vane plated with palladium, which functions as a catalyst, over 10,000 times per minute, giving “vibration energy” over 10,000 times per minute.

However, when the vibration agitation was stopped, the “gas,” which made the liquid turbid, floated and the liquid became “transparent” several minutes later. Immediately after the vibration agitation was resumed, the liquid became turbid due to the “gas.”

The above embodiments verify that by applying the element conversion technology of the present invention to calcium, copper, or magnesium solution, it is possible to obtain considerable amounts of rare metal and noble metal, such as gold and silver.

It is noteworthy that even if the processing time is short (3 hours), it is possible to obtain large amounts of new elements from original common elements with the element conversion technology.

This is considered because as the vibrating vanes are plated with palladium, which takes an important role as a catalyst for element conversion, elements contact the palladium catalyst about 10,000 times per minute beyond our expectations through the vibration and flow of the vibrating vanes (170 Hz).

Needless to say, it is important that heavy water, which is another essential catalyst for element conversion, fulfills its function sufficiently through the strong vibration and flow which has a frequency of about 10,000 times per minute, like the catalytic reaction of palladium.

However, the application of vibration at a frequency of about 10,000 times per minute to the palladium-plated vibrating vanes is insufficient, and the most important factor is to induce “the flow of liquid in addition to vibration,” which has been already invented by the inventor.

### Possibility of Industrial Exploitation

The element conversion by inducing the vibration and flow of an aqueous solution through high-frequency agitation inside a tank with an element to be converted is an epoch-making invention, and will pave the way for converting many kinds of elements into other elements easily.

The method for converting an element into another element safely and easily at room temperatures by setting and activating in a tank a high-frequency agitator properly matching the capacity of the tank will contribute significantly to the production of necessary amounts of target elements through element conversion.

In addition, as shown in the embodiments, the conversion of cesium into other elements, including barium and platinum, in a short period of time could be significant technological innovation that would contribute the early actualization of the safe society, as we are now faced with difficulty in disposing of radioactive pollutants.

As it is obvious from the processing results of tritium water, obtaining epoch-making data, in which the concentration of “tritium,” which is a global problem, was reduced to about one sixteenth by running a palladium-plated “high-frequency vibration agitator” at 170 Hz for 25 hours, can be considered as a technological breakthrough, which would help dispel the “fear of tritium” in the world, including Fukushima.

### EXPLANATION OF SIGNS

1 Tank
2 Aqueous solution (including an element)
3 High-frequency vibration motor
4 Vibrating rod
5 Multistep vibrating vane
6 Inverter
7 Insulator
8 Rectifier

What is claimed is:

1. A system for treating an aqueous solution using a high-frequency vibration agitator, the high-frequency vibration agitator comprising:
a tank into which an aqueous solution is input;
a high-frequency vibration motor;
an inverter that controls the high-frequency vibration motor;
a vibrating rod that vibrates according to the high-frequency vibration motor and extends in the tank;
a vibrator vibrating vane that is attached to the vibrating rod in the aqueous solution in the tank and causes high-frequency vibration dispersion of the aqueous solution; and
a circuit for connecting the vibrating rod to a DC power source,
wherein the vibrator vibrating vane comprises a plurality of vibrators vibrating vanes and the plurality of vibrators vibrating vanes are attached to the vibrating rod in a multistep manner;
wherein each of the plurality of vibrators vibrating vanes includes a first portion electrically connected to the vibrating rod and a second portion which is a portion different from the first portion and is attached, in an insulated manner, to the vibrating rod;
wherein the vibrating rod comprises one vibrating rod and another vibrating rod;
wherein one of the first portion and the second portion of each of the plurality of vibrators vibrating vanes is connected to the one vibrating rod and the other portion of the first portion and the second portion of each of the plurality of vibrating vanes is connected to the other vibrating rod;
wherein the plurality of vibrators vibrating vanes being secured to the vibrating rod in the multistep manner means that the first portion and the second portion of each of the plurality of vibrators vibrating vanes are connected alternately to the one vibrating rod and the other vibrating rod;
wherein the high-frequency vibration motor vibrates the plurality of vibrators vibrating vanes at a frequency of 100 to 170 Hz in the aqueous solution;
wherein a palladium catalyst or platinum catalyst for treating the aqueous solution by means of high-frequency vibration agitation is formed on a surface of each of the plurality of vibrators vibrating vanes;
wherein tritium is contained in the aqueous solution in the tank; and
wherein along with the high-frequency vibration agitation of the aqueous solution by the high-frequency vibration motor, electrolysis of the aqueous solution is caused by the circuit connecting the one vibrating rod and the other vibrating rod to the DC power source.

2. The system of claim 1, wherein tritium water of 0.5 to 5 μSv is added with a concentration of 5 to 50% to the aqueous solution in the tank.

3. The system of claim 1, wherein the circuit applies an electric current of 0.5 to 4 A/dm2 to the vibrating rod.

4. The system of claim 1, wherein the aqueous solution is treated at temperature in a range of 15° C. to 30° C.

5. The system of claim 1, wherein the high-frequency vibration agitator includes a bubbling tank that is connected to the tank via a pipe and is designed to treat gases generated by the electrolysis.

6. A system for treating an aqueous solution using a high-frequency vibration agitator, the high-frequency vibration agitator comprising:
a tank into which an aqueous solution is input;
a high-frequency vibration motor;
an inverter that controls the high-frequency vibration motor;
a vibrating rod that vibrates according to the high-frequency vibration motor and extends in the tank;
a vibrating vane that is attached to the vibrating rod in the aqueous solution in the tank and causes high-frequency vibration dispersion of the aqueous solution; and
a circuit for connecting the vibrating rod to a DC power source,
wherein the vibrating vane comprises a plurality of vibrating vanes and the plurality of vibrating vanes are attached to the vibrating rod in a multistep manner;
wherein each of the plurality of vibrating vanes includes a first portion electrically connected to the vibrating rod and a second portion which is a portion different from the first portion and is attached, in an insulated manner, to the vibrating rod;
wherein the vibrating rod comprises one vibrating rod and another vibrating rod;
wherein one of the first portion and the second portion of each of the plurality of vibrating vanes is connected to the one vibrating rod and the other portion of the first portion and the second portion of each of the plurality of vibrating vanes is connected to the other vibrating rod;
wherein the plurality of vibrating vanes being secured to the vibrating rod in the multistep manner means that the first portion and the second portion of each of the plurality of vibrating vanes are connected alternately to the one vibrating rod and the other vibrating rod;
wherein the high-frequency vibration motor vibrates the plurality of vibrating vanes at a frequency of 100 to 170 Hz in the aqueous solution;
wherein a palladium catalyst or platinum catalyst for treating the aqueous solution by means of high-frequency vibration agitation is formed on a surface of each of the plurality of vibrating vanes;
wherein heavy water is contained in the aqueous solution in the tank and a concentration of the heavy water to the aqueous solution is 0.1 to 5%; and
wherein along with the high-frequency vibration agitation of the aqueous solution by the high-frequency vibration motor, electrolysis of the aqueous solution is caused by the circuit connecting the one vibrating rod and the other vibrating rod to the DC power source.
